(19) United States
(12) Patent Application Publication
(10) Pub. No.: US 2022/0129859 A1
(43) Pub. Date: Apr. 28, 2022

(54) INFORMATION PROCESSING DEVICE, INFORMATION PROCESSING METHOD, AND PROGRAM

(71) Applicant: Toyota Jidosha Kabushiki Kaisha, Toyota-shi Aichi-ken (JP)

(72) Inventors: Osamu Izumida, Nagoya-shi (JP); Mitsuhiro Miura, Okazaki -shi (JP); Xin Jin, Nagoya-shi (JP); Genshi Kuno, Kasugai-shi (JP)

(73) Assignee: Toyota Jidosha Kabushiki Kaisha, Toyota-shi Aichi-ken (JP)

(21) Appl. No.: 17/395,884

(22) Filed: Aug. 6, 2021

(30) Foreign Application Priority Data
Oct. 22, 2020 (JP) 2020-177614

(51) Int. Cl. G06Q 10/10; G06Q 10/02; G06Q 10/04

(52) U.S. Cl. CPC G06Q 10/1095; G06Q 10/04; G06Q 10/02

(57) ABSTRACT

A controller in an information processing device is configured to acquire first information about a plurality of users respectively present at a plurality of locations within a predetermined region, the first information including information related to a current behavior of each of the users at each of the locations or a behavior predicted to be taken by each of the users at each of the locations within a predetermined period. Further, the controller is configured to decide order of visiting when a visitor who visits the users visits the users based on the first information.

### CROSS-REFERENCE TO RELATED APPLICATION

This application claims priority to Japanese Patent Application No. 2020-177614 filed on Oct. 22, 2020, incorporated herein by reference in its entirety.

### BACKGROUND

### 1. Technical Field

The present disclosure relates to an information processing device, an information processing method, and a program.

### 2. Description of Related Art

Japanese Unexamined Patent Application Publication No. 2003-323540 (JP 2003-323540 A) discloses a method in which a computer supports the creation of a visit schedule to a plurality of visiting facilities associated with business activities and the like. The method disclosed in JP 2003-323540 A includes a step of selecting the visiting facilities within a predetermined area, a step of obtaining position data of each visiting facility, and a step of reading scale data indicating the scale of each visiting facility. Further, the method disclosed in JP 2003-323540 A includes a step of predicting staying time of each visiting facility based on the scale data, and a step of calculating order of visiting each visiting facility based on the position data of each visiting facility and prediction data of the staying time.

### SUMMARY

The present disclosure is to suppress a visitor who visits a user from visiting the user at an unsuitable timing.

A first aspect of the present disclosure relates to an information processing device including a controller. The controller is configured to execute acquiring first information about a plurality of users respectively present at a plurality of locations within a predetermined region, the first information including information related to a current behavior of each of the users at each of the locations or a behavior predicted to be taken by each of the users at each of the locations within a predetermined period. The controller is configured to decide order of visiting when a visitor who visits the users visits the users based on the first information.

A second aspect of the present disclosure relates to an information processing method executed by a computer. The method includes acquiring first information about a plurality of users respectively present at a plurality of locations within a predetermined region, the first information including information related to a current behavior of each of the users at each of the locations or a behavior predicted to be taken by each of the users at each of the locations within a predetermined period, and deciding order of visiting when a visitor who visits the users visits the users based on the first information.

A third aspect of the present disclosure relates to a program that causes a computer to execute an information processing method. The method includes acquiring first information about a plurality of users respectively present at a plurality of locations within a predetermined region, the first information including information related to a current behavior of each of the users at each of the locations or a behavior predicted to be taken by each of the users at each of the locations within a predetermined period, and deciding order of visiting when a visitor who visits the users visits the users based on the first information.

According to the present disclosure, the visitor who visits the user can be suppressed from visiting the user at an unsuitable timing.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a management system;

FIG. 2 is a block diagram schematically showing an example of a functional configuration of each of a camera, a visitor terminal, and a management server;

FIG. 3 is a diagram showing an example of a table configuration of user information stored in a user information database in a first embodiment;

FIG. 4 is a flowchart of a generating process;

FIG. 5 is a flowchart of a transmitting process; and

FIG. 6 is a diagram showing an example of a table configuration of user information stored in a user information database in a second embodiment.

### DETAILED DESCRIPTION OF EMBODIMENTS

An information processing device according to a first aspect of the present disclosure is an information processing device that performs management of a visitor who visits a plurality of users. Here, the users are present at a plurality of locations within a predetermined region. Further, the predetermined region is a region in which the visitor visits the users. A controller in the information processing device according to the first aspect of the present disclosure acquires first information. Here, the first information is information about the users respectively present at the locations. The first information also includes information related to a current behavior of each user at each location or a behavior predicted to be taken by each user at each location within a predetermined period. The controller decides order of visiting when the visitor visits the users based on the first information.

As described above, the controller in the information processing device decides the order of visiting in which the visitor visits the users based on the information related to the current behavior or the behavior predicted to be taken of each user at each location within the predetermined period. As a result, a situation in which at the timing when the visitor visits one user among the users, the one user takes a behavior that cannot respond to a visit of the visitor can be suppressed. Therefore, the visitor can be suppressed from visiting the user at an unsuitable timing.

Hereinafter, specific embodiments of the present disclosure will be described based on the drawings. Unless otherwise specified, the dimensions, materials, shapes, relative arrangements, and the like of the components described in the present embodiment are not intended to limit the technical scope of the present disclosure solely thereto.

### First Embodiment

Overview of System

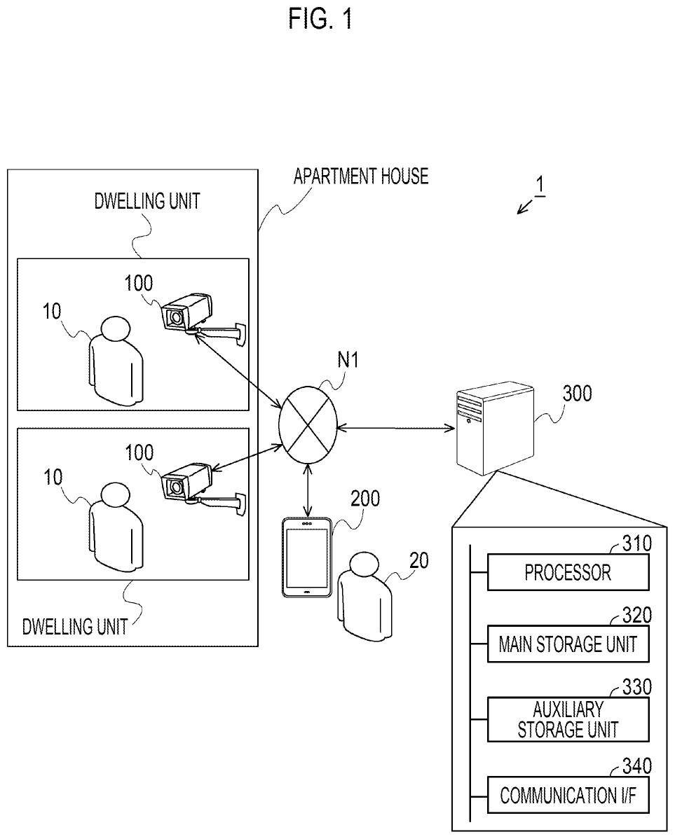

A management system 1 in the present embodiment will be described based on FIG. 1. FIG. 1 is a diagram showing a schematic configuration of the management system 1. The management system 1 is configured to include a plurality of cameras 100, a visitor terminal 200, and a management server 300.

In the management system 1, the cameras 100, the visitor terminal 200, and the management server 300 are connected to each other by a network N1. As the network N1, a wide area network (WAN) that is a worldwide public communication network, such as the Internet, or telephone communication networks, such as a mobile phone, may be employed.

Visitor Terminal 200

The visitor terminal 200 is a terminal related to a visitor 20. For example, the visitor terminal 200 is a computer or a mobile information terminal used by the visitor 20. Here, the visitor 20 visits a plurality of users 10 in an apartment house. Further, the users 10 are present in a plurality of dwelling units in the apartment house. Further, the visitor 20 is, for example, a delivery person who delivers a package to the users 10 in the apartment house or a collector who collects money from the users 10. The visitor 20 visits the users 10 based on a display on the visitor terminal 200. The apartment house in the present embodiment corresponds to a “predetermined region” according to the present disclosure. In addition, the dwelling units in the present embodiment correspond to the “locations” according to the present disclosure.

Camera 100

The camera 100 is a camera provided in the dwelling unit in which the user 10 is present. The camera 100 captures a moving image in the dwelling unit. The camera 100 transmits the captured moving image to the management server 300 via the network N1. Here, the moving image transmitted by the camera 100 to the management server 300 may include the behavior taken by the user 10 in the dwelling unit.

Management Server 300

The management server 300 is a server device that performs management of the visitor 20 who visits the users 10. The management server 300 receives the moving image from the camera 100 via the network N1. The management server 300 decides order of visiting (hereinafter, may be simply referred to as “visiting order”) when the visitor 20 visits the users 10 in the dwelling units in the apartment house based on the received moving image. Then, the management server 300 transmits order information including the visiting order to the visitor terminal 200 via the network N1. The visitor 20 visits the users 10 in the apartment house based on the order information. The details of a deciding method of the visiting order will be described below.

The management server 300 is configured to include a computer having a processor 310, a main storage unit 320, an auxiliary storage unit 330, and a communication interface (communication I/F) 340. The processor 310 is, for example, a central processing unit (CPU) or a digital signal processor (DSP). The main storage unit 320 is, for example, a random access memory (RAM). The auxiliary storage unit 330 is, for example, a read only memory (ROM). Further, the auxiliary storage unit 330 is, for example, a hard disk drive (HDD) or a disk recording medium, such as a CD-ROM, a DVD disk, or a Blu-ray disk. Also, the auxiliary storage unit 330 may be a removable medium (portable storage medium). Here, examples of the removable medium include a USB memory or an SD card. The communication I/F 340 is, for example, a local area network (LAN) interface board or a wireless communication circuit for wireless communication.

In the management server 300, an operating system (OS), various programs, various information tables, and the like are stored in the auxiliary storage unit 330. Further, in the management server 300, the processor 310 can realize various functions as described below by loading the programs stored in the auxiliary storage unit 330 into the main storage unit 320 and executing the programs. Note that a part or all of the functions in the management server 300 may be realized by a hardware circuit, such as an ASIC or an FPGA. The management server 300 is not always needed to be realized by a single physical configuration, and may be configured by a plurality of the computers linked to each other. Further, the camera 100 is configured to include the computer as in the management server 300. The management server 300 in the present embodiment corresponds to an “information processing device” according to the present disclosure.

Functional Configuration

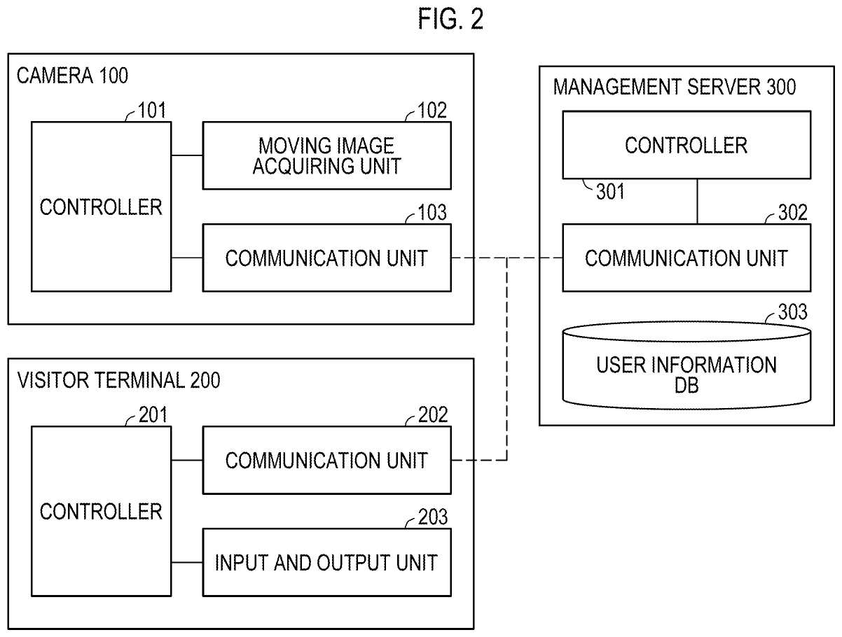

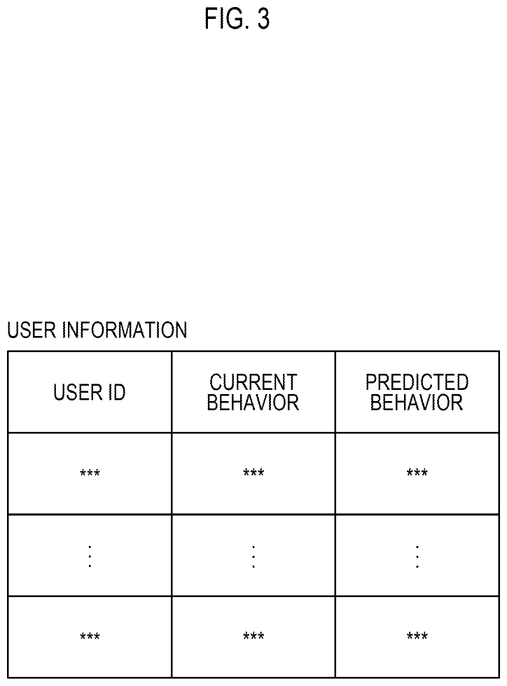

Next, the functional configurations of the camera 100, the visitor terminal 200, and the management server 300 that configure the management system 1 will be described based on FIGS. 2 to 3. FIG. 2 is a block diagram schematically showing an example of the functional configuration of each of the camera 100, the visitor terminal 200, and the management server 300.

Camera 100

The camera 100 is configured to include a controller 101, a moving image acquiring unit 102, and a communication unit 103. The controller 101 has a function of performing arithmetic processing for controlling the camera 100. The controller 101 can be realized by a processor in the camera 100. The moving image acquiring unit 102 has a function of acquiring the moving image captured by the camera 100.

The communication unit 103 has a function of connecting the camera 100 to the network N1. The communication unit 103 can be realized by a communication I/F in the camera 100. The controller 101 transmits the moving image acquired by the moving image acquiring unit 102 to the management server 300 in real time via the communication unit 103. The moving image in the present embodiment corresponds to “second information” according to the present disclosure.

Visitor Terminal 200

The visitor terminal 200 is configured to include a controller 201, a communication unit 202, and an input and output unit 203. The controller 201 can be realized by a processor in the visitor terminal 200. The communication unit 202 has a function of connecting the visitor terminal 200 to the network N1. The communication unit 202 can be realized by a communication I/F in the visitor terminal 200. The input and output unit 203 has a function for the visitor 20 to input various information to the visitor terminal 200. In addition, the input and output unit 203 has a function of displaying various information to the visitor 20. The input and output unit 203 can be realized by a touch panel of the visitor terminal 200.

When the visitor 20 enters the apartment house, the visitor 20 performs an operation of transmitting request information to the management server 300 via the input and output unit 203. In a case where this operation is performed, the controller 201 transmits the request information to the management server 300 via the communication unit 202. Here, the request information is information for requesting the management server 300 to transmit the order information.

The controller 201 receives the order information from the management server 300 via the communication unit 202. Then, the controller 201 causes the input and output unit 203 to display the visiting order included in the order information. The visitor 20 visits the users 10 in the apartment house in accordance with the display of the visiting order included in the order information. The order information in the present embodiment corresponds to “third information” according to the present disclosure.

Management Server 300

The management server 300 is configured to include a controller 301, a communication unit 302, and a user information database (user information DB) 303. The controller 301 can be realized by the processor 310 in the management server 300. The communication unit 302 has a function of connecting the management server 300 to the network N1. The communication unit 302 can be realized by the communication I/F 340 in the management server 300.

The controller 301 receives the moving image captured by the camera 100 from the camera 100 in real time via the communication unit 302. The controller 301 detects the behavior of the user 10 in the dwelling unit included in the received moving image. That is, the controller 301 detects the current behavior of the user 10 in the dwelling unit (hereinafter, may be simply referred to as “current behavior”). Here, the controller 301 detects that the user 10 is using a toilet, having a bath, or taking a meal, as the current behavior of the user 10. Then, the controller 301 stores information about the detected current behavior of each user 10 in the user information DB 303. A known method can be adopted as a detecting method of the current behavior of the user 10 based on the moving image of the user 10. For example, the controller 301 may detect the current behavior of the user 10 by detecting a current position of the user 10 included in the moving image. For example, in a case where the current position of the user 10 is a toilet, the controller 301 detects that the current behavior of the user 10 is using a toilet.

In addition, the controller 301 predicts a behavior having a possibility of being taken by the user 10 in the dwelling unit within a predetermined period. Here, the predetermined period is, for example, a period in which the visitor 20 is present in the apartment house to visit the users 10. The controller 301 predicts the behavior having a possibility of being taken by the user 10 within the predetermined period based on the moving image received from the camera 100. Specifically, the controller 301 predicts the behavior of the user 10 based on the current behavior of the user 10 detected from the moving image. Then, the controller 301 stores information about the predicted behavior of each user 10 (hereinafter, may be simply referred to as “predicted behavior”) in the user information DB 303. A known method can be adopted as a predicting method of the behavior of the user 10 by the controller 301. For example, the controller 301 may acquire a behavior history of the user 10 and predict the behavior of the user 10 based on the behavior history. For example, it is assumed that the behavior history of the user 10 records that the user 10 is more likely to use a toilet after taking a meal than to take other behaviors after taking a meal. In this case, in a case where the controller 301 detects that the user 10 is currently taking a meal, the controller 301 predicts that the user 10 will use a toilet after taking a meal based on the behavior history of the user 10. In this way, the controller 301 generates user information including the information about the current behavior of each user 10 and the predicted behavior of each user 10.

The user information DB 303 is a database that stores the information about each of the users 10. The user information DB 303 can be realized by the auxiliary storage unit 330 in the management server 300. FIG. 3 is a diagram showing an example of a table configuration of the user information stored in the user information DB 303 in the present embodiment. As shown in FIG. 3, the user information includes a user ID field, a current behavior field, and a predicted behavior field. A user ID that is an identifier for specifying each user 10 is input to the user ID field. The current behavior of each user 10 is input to the current behavior field. The predicted behavior of each user 10 is input to the predicted behavior field. The user information in the present embodiment corresponds to “first information” according to the present disclosure.

The controller 301 receives the request information from the visitor terminal 200 via the communication unit 302. Then, the controller 301 acquires the user information stored in the user information DB 303. That is, the controller 301 acquires the information including the current behavior of each user 10 and the predicted behavior of each user 10. Then, the controller 301 decides the visiting order when the visitor 20 visits the users 10 based on the acquired user information. Here, in a case where the user 10 takes a predetermined behavior that cannot respond to the visit of the visitor 20, the user 10 cannot respond to the visit of the visitor 20. In the present embodiment, the predetermined behavior is using a toilet or having a bath. Therefore, the controller 301 decides the visiting order of the user 10, among the users 10, of which the current behavior included in the user information is not the predetermined behavior to be higher than the visiting order of the user 10 of which the current behavior included in the user information is the predetermined behavior (hereinafter, may be referred to as a “first user 10”). Here, the controller 301 decides the visiting order of a predetermined number of the users 10 of which the current behavior included in the user information is not the predetermined behavior to be higher than the visiting order of the first user 10. The predetermined number of the users is decided depending on the current behavior of the first user 10. Specifically, the predetermined number of the users is decided to be large as the time needed for the current behavior of the first user 10 is long. The visitor 20 visits the user 10 having a high visiting order earlier than the user 10 having a low visiting order. Therefore, when the visitor 20 visits the users 10, the visitor 20 can visit the user 10 having a high visiting order of which the current behavior is not the predetermined behavior, and then visit the first user 10. As a result, the visitor 20 can easily visit the first user 10 who is currently taking the predetermined behavior after the first user 10 finishes the predetermined behavior.

Further, the controller 301 decides the visiting order of the user 10, among the users 10, of which the predicted behavior included in the user information is the predetermined behavior (hereinafter, may be referred to as a “second user 10”) to be higher than the visiting order of the user 10 other than the second user 10. Therefore, when the visitor 20 visits the users 10, the visitor 20 can visit the second user 10 before visiting the users 10 other than the second user 10. As a result, the visitor 20 can easily visit the second user 10 before the second user 10 takes the predicted behavior within the predetermined period.

Generating Process

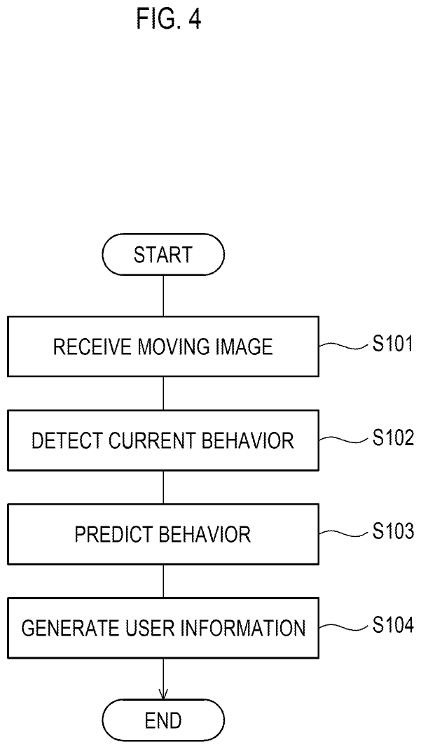

In the management system 1, a generating process executed by the controller 301 in the management server 300 will be described based on FIG. 4. FIG. 4 is a flowchart of the generating process. The generating process is a process in which the management server 300 generates the user information. The generating process is periodically executed at predetermined intervals.

In the generating process, first, in S101, the moving image of each user 10 is received from each camera 100. Next, in S102, the current behavior of each user 10 is detected based on the received moving image. Further, in S103, the behavior having a possibility of being taken by each user 10 within the predetermined period in the dwelling unit is predicted. Then, in S104, the user information is generated by storing the information about the current behavior of each user 10 and the information about the predicted behavior of each user 10 in the user information DB 303.

Transmitting Process

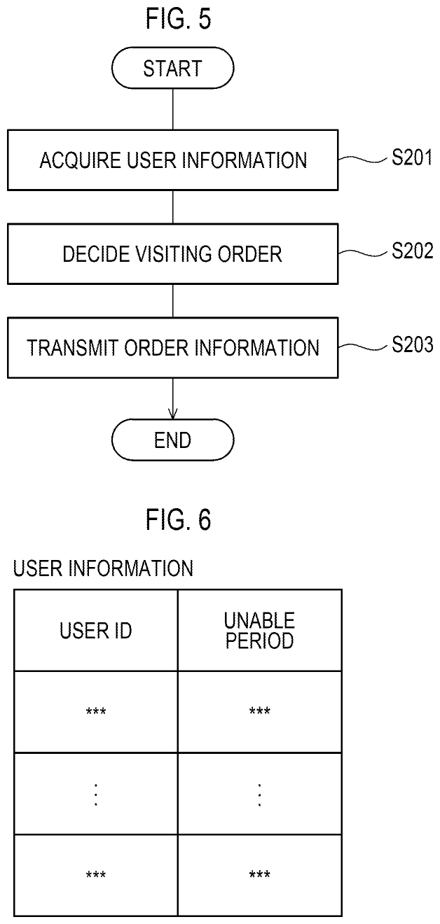

Next, in the management system 1, a transmitting process executed by the controller 301 in the management server 300 will be described based on FIG. 5. FIG. 5 is a flowchart of the transmitting process. The transmitting process is a process in which the management server 300 transmits the order information to the visitor terminal 200. The transmitting process is executed when the management server 300 receives the request information from the visitor terminal 200.

In the transmitting process, first, in S201, the user information stored in the user information DB 303 is acquired. Here, the visitor 20 operates the visitor terminal 200 to transmit the request information when the visitor 20 enters the apartment house. Accordingly, the user information is acquired when the visitor 20 enters the apartment house. Next, in S202, the visiting order is decided based on the acquired user information. Then, in S203, the order information including the decided visiting order is transmitted to the visitor terminal 200. Then, the transmitting process is finished. By transmitting the order information from the management server 300 to the visitor terminal 200, the visitor terminal 200 can display the visiting order including the order information. As a result, the visitor 20 can grasp the order of visiting the users 10 in the apartment house based on the visiting order.

As described above, the management system 1 decides the visiting order based on the current behavior and the predicted behavior of each of the users 10. Therefore, a situation in which at the timing when the visitor 20 visits one user 10 among the users 10, the one user 10 takes the predetermined behavior and cannot respond to the visit of the visitor 20 can be suppressed. Therefore, the visitor 20 can be suppressed from visiting the user 10 at an unsuitable timing. Further, the visitor 20 can visit each user 10 in a state in which visiting each user 10 at an unsuitable timing is suppressed, and thus the visitor 20 can efficiently visit each user 10.

In the present embodiment, the management server 300 receives the moving image from the camera 100 provided in the dwelling unit. Then, the management server 300 decides the visiting order based on the received moving image. However, the management server 300 may decide the visiting order based on information other than the moving image. The management server 300 may decide the visiting order based on, for example, biometric information of the user 10. In this case, the management server 300 receives the biometric information of the user 10 from a biosensor that acquires the biometric information of the user 10. Here, the biosensor is present in the dwelling unit in which the user 10 is present. The management server 300 detects the current behavior of the user 10 based on the received biometric information.

In addition, the management server 300 predicts the behavior having a possibility of being taken by the user 10 within the predetermined period based on the received biometric information. Then, the management server 300 stores the detected current behavior of the user 10 and the predicted behavior of the user 10 in the user information DB 303 as the user information. Here, examples of the biometric information of the user 10 include an amount of urine in the bladder of the user 10 and the like. In this case, the management server 300 predicts that the user 10 will use a toilet based on the amount of urine in the bladder of the user 10. In this way, the management server 300 generates the user information including the current behavior of the user 10 and the predicted behavior of the user 10 based on the biometric information.

In this way, the management server 300 may receive the information about each user 10 acquired by the sensor (camera 100, biosensor, or the like) present in each dwelling unit. In this case, the management server 300 generates the user information based on the information about each user 10 received from each sensor.

Further, the management server 300 may decide the visiting order based on, for example, schedule information including a schedule of the behavior to be taken by the user 10 in the dwelling unit. In this case, the management server 300 receives the schedule information of the user 10 from a server device or the like that manages the schedule information of the user 10, and stores the schedule information of the user 10 in the user information DB 303 as the user information. Therefore, the management server 300 can grasp the current behavior of the user 10 in the dwelling unit and the predicted behavior of the user 10. Here, for example, the user 10 who is holding a web conference in the dwelling unit cannot respond to the visit of the visitor 20. Then, the management server 300 decides the visiting order based on the schedule for the web conference in the schedule information.

Further, in the present embodiment, the visitor 20 visits the users 10 present in the dwelling units in the apartment house. However, the visitor 20 may visit the users 10 in a predetermined area or a predetermined zone, for example. In this case, the visitor 20 visits the users 10 present in a plurality of buildings in the predetermined area or the predetermined zone. Then, the management server 300 transmits the order information including the visiting order of the users 10 in the predetermined area or the predetermined zone to the visitor terminal 200.

Also, in the present embodiment, when the visitor 20 enters the apartment house, the request information is transmitted from the visitor terminal 200 to the management server 300. However, the timing at which the request information is transmitted to the management server 300 may not always be the timing at which the visitor 20 enters the apartment house. That is, the timing at which the management server 300 acquires the user information may not be the timing at which the visitor 20 enters the apartment house. For example, the visitor 20 first transmits the request information to the management server 300 by using the visitor terminal 200 when the visitor 20 enters the apartment house. Thereafter, the visitor 20 may transmit the request information again to the management server 300 by using the visitor terminal 200 while visiting the users 10. In this case, the management server 300 acquires the user information about the users 10 other than the user 10 who has finished the visit by the visitor 20. Then, the management server 300 decides the visiting order of the users 10 other than the user 10 who has finished the visit by the visitor 20.

Further, in the present embodiment, the predetermined behavior is using a toilet or having a bath. However, the predetermined behavior is not always limited to using a toilet or having a bath as long as the behavior of the user 10 cannot respond to the visit of the visitor 20.

Further, the visitor 20 may be, for example, an autonomous mobile body that delivers the package to the users 10 in the apartment house. In this case, the autonomous mobile body receives the order information from the management server 300. Then, the autonomous mobile body visits each user 10 in the apartment house and delivers the package by autonomous movement in accordance with the visiting order in the order information.

Further, in the present embodiment, the user information includes the information about the current behavior of each user 10 and the information about the predicted behavior of each user 10. However, the user information may not always include both the information about the current behavior of each user 10 and the information about the predicted behavior of each user 10. The user information may be information including any one of the information about the current behavior of each user 10 or the information about the predicted behavior of each user 10. In this case, the management server 300 decides the visiting order based on the current behavior of each user 10 or the predicted behavior of each user 10 in the user information.

### Second Embodiment

In a second embodiment, the management server 300 specifies a period during which the user 10 cannot respond to the visit of the visitor 20 (hereinafter, may be referred to as an “unable period”). Then, the management server 300 decides the visiting order based on the unable period. Hereinafter, solely the points different from the first embodiment will be described.

Management Server 300

In the present embodiment, the controller 301 in the management server 300 specifies the unable period of the user 10 based on the detected current behavior of the user 10. In this case, in a case where the user 10 is currently taking the predetermined behavior, the controller 301 specifies the unable period depending on the content of the predetermined behavior. The controller 301 specifies a period from the current time until a predetermined time corresponding to the predetermined behavior currently taken by the user 10 elapses as the unable period of the user 10. Here, the predetermined time is decided based on, for example, the behavior history of the user 10. In this case, the controller 301 acquires the length of time that the user 10 takes the predetermined behavior in the past. Then, the controller 301 decides the length of time that the user 10 takes the predetermined behavior in the past as the predetermined time. Further, the predetermined time may be decided in advance for each predetermined behavior.

Further, when the controller 301 predicts the behavior of the user 10, the controller 301 specifies the time when the user 10 starts the behavior (that is, the time when the predicted behavior is started). Then, in a case where the predicted behavior of the user 10 is the predetermined behavior, the controller 301 specifies a period from the specified time when the user 10 starts the predetermined behavior until the predetermined time corresponding to the predetermined behavior elapses as the unable period. In this way, the controller 301 specifies the unable period as the period during which the user 10 cannot respond to the visit of the visitor 20 due to the current behavior of the user 10 and the predicted behavior of the user 10. Then, the controller 301 generates the user information by storing the information about the unable period of each user 10 as the user information in the user information DB 303.

FIG. 6 is a diagram showing an example of a table configuration of the user information stored in the user information DB 303 in the present embodiment. As shown in FIG. 6, the user information includes the user ID field and an unable period field. The unable period of each user 10 is input to the unable period field. Here, a case is assumed in which the current behavior of the user 10 input to the current behavior field and the predicted behavior of the user 10 input to the predicted behavior field are the predetermined behavior, respectively. In this case, two response unable periods of the unable period corresponding to the current behavior (predetermined behavior) of the user 10 and the unable period corresponding to the predicted behavior (predetermined behavior) of the user 10 are input to the unable period field.

The controller 301 decides the visiting order based on the user information stored in the user information DB 303. Specifically, the controller 301 acquires the response unable period included in the user information. Then, the controller 301 decides the visiting order such that the time when the visitor 20 visits each user 10 is not included in the unable period of each user 10. By deciding the visiting order in this way, a situation in which the user 10 takes the predetermined behavior when the visitor 20 visits the user 10 can be suppressed.

The transmitting process in the present embodiment is the same as that in the first embodiment, and thus the description thereof will be omitted.

As described above, with the management system 1 in the present embodiment, the visitor 20 can be suppressed from visiting the user 10 at an unsuitable timing.

### Other Embodiments

The embodiments described above are merely examples, and the present disclosure can be implemented with appropriate modifications within a scope not departing from the gist of the present disclosure. Further, the processing and structure described in the present disclosure can be freely combined and implemented as long as no technical inconsistency occurs.

The processing performed by one device in the description may be allocated and executed by a plurality of devices. Alternatively, the processing performed by different devices in the description may be executed by one device. In the computer system, the hardware configuration (server configuration) that realizes each function can be flexibly changed.

The present disclosure can also be realized by supplying a computer program that implements the functions described in the above embodiments to a computer, and reading and executing the program by one or more processors included in the computer. Such a computer program may be provided to the computer by a non-transitory computer-readable storage medium that can be connected to a system bus of the computer, or may be provided to the computer via a network. The non-transitory computer-readable storage medium includes, for example, any type of disk, such as a magnetic disk (floppy (registered trademark) disk, hard disk drive (HDD), or the like) or an optical disk (CD-ROM, DVD disk, Blu-ray disk, or the like), and any type of media suitable for storing an electronic command, such as a read only memory (ROM), a random access memory (RAM), an EPROM, an EEPROM, a magnetic card, a flash memory, or an optical card.

What is claimed is:

1. An information processing device comprising a controller configured to execute
acquiring first information about a plurality of users respectively present at a plurality of locations within a predetermined region, the first information including information related to a current behavior of each of the users at each of the locations or a behavior predicted to be taken by each of the users at each of the locations within a predetermined period, and
deciding order of visiting when a visitor who visits the users visits the users based on the first information.

2. The information processing device according to claim 1, wherein:
the first information includes the information related to the current behavior of each of the users at each of the locations; and
the controller is configured to decide order of visiting a user, among the users, of which the current behavior included in the first information is not a predetermined behavior that cannot respond to a visit of the visitor to be higher than order of visiting a first user of which the current behavior included in the first information is the predetermined behavior.

3. The information processing device according to claim 1, wherein:
the first information includes the information related to the behavior predicted to be taken by each of the users at each of the locations within the predetermined period; and
the controller is configured to decide order of visiting a second user, among the users, of which the behavior predicted to be taken within the predetermined period included in the first information is a predetermined behavior that cannot respond to a visit of the visitor to be higher than order of visiting the users other than the second user.

4. The information processing device according to claim 1, wherein the first information is information about a period during which each of the users cannot respond to a visit of the visitor due to the current behavior or the behavior predicted to be taken within the predetermined period.

5. The information processing device according to claim 1, wherein the controller is configured to further execute
receiving second information about each of the users acquired by sensors respectively present at the locations from the sensors,
detecting the current behavior of each of the users at each of the locations based on the second information or predicting a behavior having a possibility of being taken by each of the users at each of the locations within the predetermined period based on the second information, and
generating the first information based on a result of the detecting or a result of the predicting.

6. The information processing device according to claim 1, wherein the controller is configured to further execute transmitting third information including the order to a terminal related to the visitor.

7. The information processing device according to claim 6, wherein the controller is configured to, in a case where information for requesting the transmitting of the third information is received from the terminal, execute acquiring the first information.

8. An information processing method executed by a computer, the method comprising:
acquiring first information about a plurality of users respectively present at a plurality of locations within a predetermined region, the first information including information related to a current behavior of each of the users at each of the locations or a behavior predicted to be taken by each of the users at each of the locations within a predetermined period; and
deciding order of visiting when a visitor who visits the users visits the users based on the first information.

9. The information processing method according to claim 8, wherein:
the first information includes the information related to the current behavior of each of the users at each of the locations; and
order of visiting a user, among the users, of which the current behavior included in the first information is not a predetermined behavior that cannot respond to a visit of the visitor is decided to be higher than order of visiting a first user of which the current behavior included in the first information is the predetermined behavior.

10. The information processing method according to claim 8, wherein:
the first information includes the information related to the behavior predicted to be taken by each of the users at each of the locations within the predetermined period; and
order of visiting a second user, among the users, of which the behavior predicted to be taken within the predetermined period included in the first information is a predetermined behavior that cannot respond to a visit of the visitor is decided to be higher than order of visiting the users other than the second user.

11. The information processing method according to claim 8, wherein the first information is information about a period during which each of the users cannot respond to a visit of the visitor due to the current behavior or the behavior predicted to be taken within the predetermined period.

12. The information processing method according to claim 8, further comprising:
receiving second information about each of the users acquired by sensors respectively present at the locations from the sensors;
detecting the current behavior of each of the users at each of the locations based on the second information or predicting a behavior having a possibility of being taken by each of the users at each of the locations within the predetermined period based on the second information; and
generating the first information based on a result of the detecting or a result of the predicting.

13. The information processing method according to claim 8, further comprising transmitting third information including the order to a terminal related to the visitor.

14. The information processing method according to claim 13, wherein in a case where information for requesting the transmitting of the third information is received from the terminal, acquiring the first information is executed.

15. A program that causes a computer to execute an information processing method comprising:
acquiring first information about a plurality of users respectively present at a plurality of locations within a predetermined region, the first information including information related to a current behavior of each of the users at each of the locations or a behavior predicted to be taken by each of the users at each of the locations within a predetermined period; and
deciding order of visiting when a visitor who visits the users visits the users based on the first information.

16. The program according to claim 15, wherein:
the first information includes the information related to the current behavior of each of the users at each of the locations; and
order of visiting a user, among the users, of which the current behavior included in the first information is not a predetermined behavior that cannot respond to a visit of the visitor is decided to be higher than order of visiting a first user of which the current behavior included in the first information is the predetermined behavior.

17. The program according to claim 15, wherein:
the first information includes the information related to the behavior predicted to be taken by each of the users at each of the locations within the predetermined period; and
order of visiting a second user, among the users, of which the behavior predicted to be taken within the predetermined period included in the first information is a predetermined behavior that cannot respond to a visit of the visitor is decided to be higher than order of visiting the users other than the second user.

18. The program according to claim 15, wherein the first information is information about a period during which each of the users cannot respond to a visit of the visitor due to the current behavior or the behavior predicted to be taken within the predetermined period.

19. The program according to claim 15, wherein the information processing method further comprises
receiving second information about each of the users acquired by sensors respectively present at the locations from the sensors,
detecting the current behavior of each of the users at each of the locations based on the second information or predicting a behavior having a possibility of being taken by each of the users at each of the locations within the predetermined period based on the second information, and
generating the first information based on a result of the detecting or a result of the predicting.

20. The program according to claim 15, wherein the information processing method further comprises transmitting third information including the order to a terminal related to the visitor.
